(19) United States
(12) Patent Application Publication
(10) Pub. No.: US 2021/0206502 A1
(43) Pub. Date: Jul. 8, 2021

(54) EDUCTOR HOUSING WITH LOBED PLENUM DIVIDER

(71) Applicant: The Boeing Company, Chicago, IL (US)

(72) Inventors: Ryan M. Boufford, Seal Beach, CA (US); Sean P. Howe, Snohomish, WA (US)

(21) Appl. No.: 16/734,825

(22) Filed: Jan. 6, 2020

(51) Int. Cl. B64D 33/04; B64D 41/00

(52) U.S. Cl. CPC B64D 33/04; B64D 41/00

(57) ABSTRACT

An eductor housing for an auxiliary power unit is disclosed, and includes a main body defining a longitudinal axis, a primary plenum, a secondary plenum, an inlet opening, and an outlet opening. The inlet opening is fluidly connected to the outlet opening. The primary plenum is separate from the secondary plenum and the primary plenum and the secondary plenum are fluidly connected to the outlet opening of the main body. The eductor housing also includes a plenum divider disposed around the outlet opening of the eductor housing. The plenum divider includes a plurality of chutes separated by a plurality of lobes. The plenum divider separates the primary plenum from the secondary plenum and the plurality of lobes extend radially inward towards the longitudinal axis of the main body of the eductor housing.

### INTRODUCTION

The present disclosure relates to an eductor for an auxiliary power unit of an aircraft. More particularly, the present disclosure is directed towards an eductor housing having a lobed plenum divider.

### BACKGROUND

An aircraft may include an auxiliary power unit, which serves as an additional energy source for starting a main engine. The auxiliary power unit may also provide the power required to operate onboard lighting, galley electrics, and cockpit avionics while the aircraft is parked at the gate. The auxiliary power unit is typically a gas turbine mounted in a compartment located within the tail cone of the aircraft.

During operation, a gas turbine produces exhaust gases that are directed through a nozzle and out of the aircraft through an aft exhaust opening in the tail cone of the aircraft. The nozzle may be connected to an eductor assembly that receives the exhaust gases generated by the gas turbine. The eductor assembly includes an eductor housing connected to an oil cooler. The oil cooler is an oil-to-air heat exchanger for cooling the oil that lubricates the gas turbine. The eductor assembly draws cooling air, which is located within the compartment of the tail cone, through the oil cooler. Specifically, as high velocity exhaust gas flows through the eductor housing, the cooling air is drawn towards an opening in the eductor housing, into the oil cooler. The eductor housing also receives surge bleed flow from the compressor of the gas turbine. The surge bleed flow refers to the surge air from a load compressor or, alternatively, bleed air from a power compressor. It is desirable to provide an eductor that improves the mixing of the engine exhaust and the surge bleed to improve the performance of the auxiliary power unit.

### SUMMARY

According to several aspects, an eductor housing for an auxiliary power unit is disclosed, and includes a main body defining a longitudinal axis, a primary plenum, a secondary plenum, an inlet opening, and an outlet opening. The inlet opening is fluidly connected to the outlet opening. The primary plenum is separate from the secondary plenum and the primary plenum and the secondary plenum are fluidly connected to the outlet opening of the main body. The eductor housing also includes a plenum divider disposed around the outlet opening of the eductor housing. The plenum divider includes a plurality of chutes separated by a plurality of lobes. The plenum divider separates the primary plenum from the secondary plenum and the plurality of lobes extend radially inward towards the longitudinal axis of the main body of the eductor housing.

In another aspect, a method for mixing cooling air with surge bleed flow by an eductor housing is disclosed. The method includes receiving the cooling air by a first opening in a main body of the eductor housing. The first opening is fluidly connected to a primary plenum of the eductor housing. The method also includes directing the cooling air out of the eductor housing by the primary plenum, where the cooling air exits the eductor by a plurality of lobes that are part of a plenum divider. The method also includes receiving, by a surge bleed duct in the main body of the eductor housing, the surge bleed flow. The surge bleed duct is fluidly connected to a secondary plenum of the eductor housing. The method also includes directing the surge bleed flow out of the eductor housing by the secondary plenum. The surge bleed flow exits the eductor by a plurality of chutes that are part of the plenum divider. Finally, the method includes mixing the cooling air with the surge bleed flow together as the cooling air and the surge bleed flow exit the eductor housing, where the plenum divider is disposed around an outlet opening of the eductor housing.

In still another aspect, an eductor assembly for an aircraft is disclosed. The eductor assembly includes an auxiliary power unit including a gas turbine and a load compressor, where the gas turbine generates exhaust gases. The eductor assembly also includes an exhaust system including an exhaust nozzle and an exhaust duct. The exhaust gases are expelled from the exhaust nozzle, into the exhaust duct, and exit the aircraft. Finally, the eductor assembly includes an eductor housing. The eductor housing includes upstream end portion and a downstream end portion, where the upstream end portion of the eductor housing connects to the exhaust nozzle and the downstream end portion of the eductor housing connects to the exhaust duct. The eductor housing further includes a main body defining a longitudinal axis, a primary plenum, a secondary plenum, an inlet opening, and an outlet opening, the inlet opening fluidly connected to the outlet opening. The primary plenum is separate from the secondary plenum and the primary plenum and the secondary plenum are fluidly connected to the outlet opening of the main body. The eductor housing also includes a plenum divider disposed around the outlet opening and defining a plurality of chutes separated by a plurality of lobes. The plenum divider separates the primary plenum from the secondary plenum and the plurality of lobes extend radially inward towards the longitudinal axis of the main body of the eductor housing.

The features, functions, and advantages that have been discussed may be achieved independently in various embodiments or may be combined in other embodiments further details of which can be seen with reference to the following description and drawings.

### BRIEF DESCRIPTION OF THE DRAWINGS

The drawings described herein are for illustration purposes only and are not intended to limit the scope of the present disclosure in any way.

FIG. 1 is a cross-sectioned view of a tail cone of an aircraft containing an auxiliary power unit and the disclosed eductor assembly, according to an exemplary embodiment;

FIG. 2 is a perspective view of the auxiliary power unit and an eductor housing shown in FIG. 1, according to an exemplary embodiment;

FIG. 3 is a cross-sectioned view of the eductor housing and the auxiliary power unit, according to an exemplary embodiment;

FIG. 4 is a perspective view the eductor housing, according to an exemplary embodiment;

FIG. 5 is a cross-sectioned view of the eductor housing shown in FIG. 4 taken along Section line 4-4, according to an exemplary embodiment;

FIG. 6 is a front view of the eductor housing shown in FIG. 5, where the eductor housing includes a plenum divider having ten lobes and chutes, according to an exemplary embodiment;

FIG. 7 is a front view of an alternative embodiment of the eductor housing including a plenum divider with only two lobes and two chutes, according to an exemplary embodiment;

FIGS. 8A and 8B illustrate airflow patterns of the eductor housing, where FIG. 8A illustrates the eductor housing shown in FIG. 6 and FIG. 8B illustrates the eductor housing shown in FIG. 7, according to an exemplary embodiment;

FIG. 9 is an enlarged view of the plenum divider shown in FIG. 5, according to an exemplary embodiment; and

FIG. 10 illustrates a process flow diagram illustrating a method for mixing cooling air with surge bleed flow by the eductor housing, according to an exemplary embodiment.

### DETAILED DESCRIPTION

The present disclosure relates to an eductor for an auxiliary power unit of an aircraft, where the eductor includes a lobed plenum divider. The eductor includes a main body that defines a primary plenum, a secondary plenum, an inlet opening, and an outlet opening. Exhaust gases from the gas turbine engine enter the eductor housing through the inlet opening and exit the eductor housing through the outlet opening. The primary plenum receives cooling air from a compartment located in the tail cone of the aircraft, and the secondary plenum receives surge bleed flow from the compressor of the auxiliary power unit. The plenum divider is disposed around the outlet opening of the eductor housing and defines a plurality of chutes separated by a plurality of lobes. The plenum divider separates the primary plenum from the secondary plenum. The airflow from the primary plenum exits the eductor housing from the plurality of lobes, while the surge bleed flow exits the eductor housing from the plurality of chutes.

It is to be appreciated that the lobes and chutes formed on the plenum divider and disposed around the outlet opening of the eductor housing enables mixing of the cooling air and the surge bleed flow together with one another. The lobes and chutes also cause the cooling air and the surge bleed to become entrained into the exhaust gases that are expelled from the eductor housing.

The following description is merely exemplary in nature and is not intended to limit the present disclosure, application, or uses.

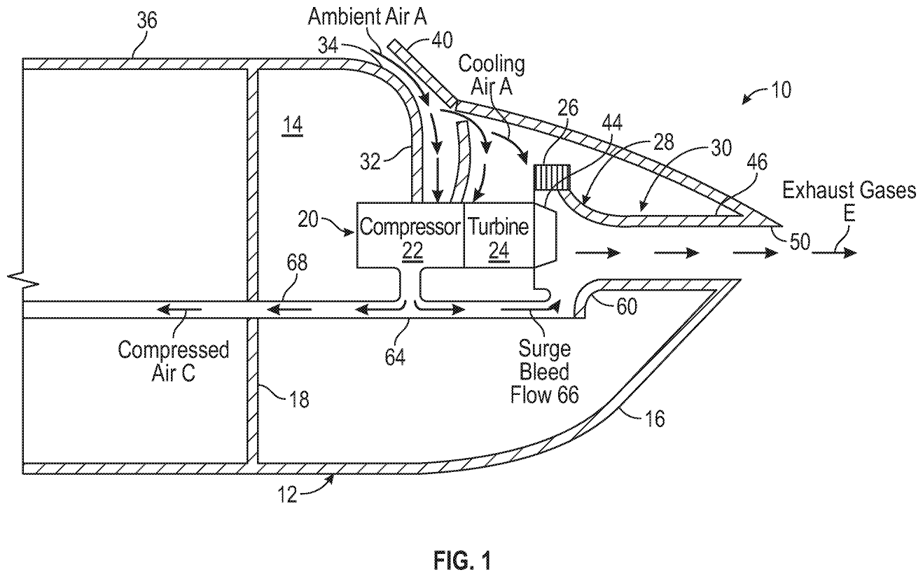

Referring to FIG. 1, a tail cone 12 of an aircraft 10 is shown. The aircraft 10 includes a compartment 14 disposed in the tail cone 12 of the aircraft 10, where the compartment 14 contains an auxiliary power unit 20. The compartment 14 is defined by a fuselage skin 16 and a dash panel 18 of the aircraft 10. The auxiliary power unit 20 includes a load compressor 22 and a gas turbine engine 24 coupled to and configured to drive the load compressor 22. FIG. 1 also illustrates an oil cooler 26 for the gas turbine engine 24, an eductor assembly 28, and an exhaust system 30. An intake duct 32 extends between an intake opening 34 and the load compressor 22 of the auxiliary power unit 20. A door 40 is disposed along an exterior surface 36 of the fuselage skin 16 and is pivotably attached to the exterior surface 36 of the aircraft 10. As seen in FIG. 1, when the door 40 is open, ambient air A flows into the load compressor 22 and the gas turbine engine 20 wherein the air is used in the combustion process. A portion of the ambient air A also enters the compartment 14 and is referred to as cooling air A. As explained below, the cooling air A is used to cool the gas turbine engine oil flowing through the oil cooler 26.

The exhaust system 30 includes an exhaust nozzle 44 that is attached to the gas turbine engine 24 and an exhaust duct 46. An eductor housing 60 is located between the exhaust nozzle 44 and the exhaust duct 46 and creates a vacuum passage between the exhaust nozzle 44 and the exhaust duct 46. In operation, the gas turbine engine 24 generates exhaust gases E, also referred to herein as driving gases, that are discharged from the exhaust nozzle 44 into the eductor housing 60 creating a low pressure region within the eductor housing 60. The low-pressure region causes atmospheric air A to be drawn from the compartment 14, through the oil cooler 26, and into the eductor housing 60 wherein the heated atmospheric air A is mixed with the gas turbine engine exhaust. The mixture of heated or spent atmospheric air and the turbine engine exhaust is referred to herein as the primary airflow 65. The primary airflow 65 is then discharged through the exhaust duct 46 and exits the aircraft 10 via an aft exhaust opening 50.

Additionally, the load compressor 22 also receives a portion of the ambient air A from the intake duct 32, compresses the ambient air A into compressed air C, and feeds the compressed air C through a conduit 68. The conduit 68 delivers the compressed air C to various pneumatic systems of the aircraft 10. However, any compressed air C not required by the various pneumatic systems, referred to herein as the surge bleed flow 66, is directed, via a least one valve (not shown), through a surge bleed conduit 64 and into the eductor housing 60. The unused compressed air C is referred to as surge bleed flow 66. The surge bleed flow 66 may also be referred to herein as the secondary airflow which is channeled through a secondary plenum 76.

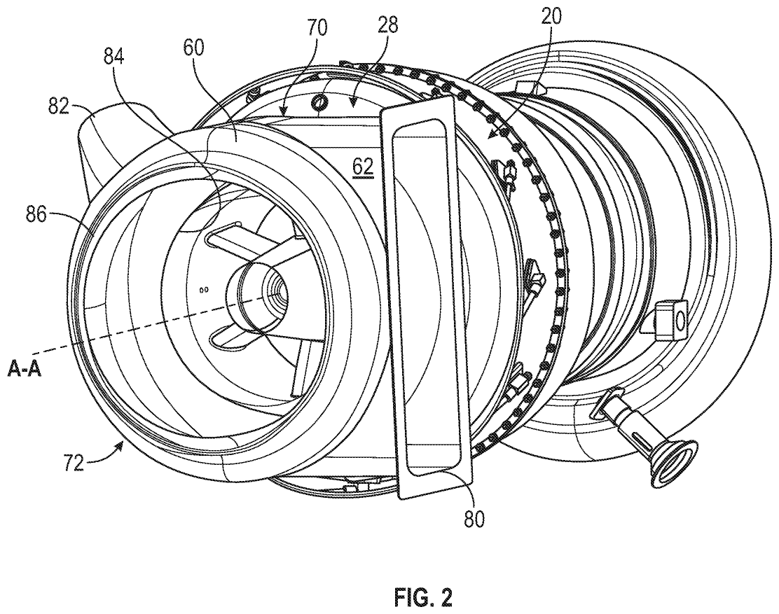

FIG. 2 is a perspective view of the auxiliary power unit 20 that includes the load compressor 22, the gas turbine engine 24, the eductor housing 60, and the exhaust nozzle 44. FIG. 3 is a cross-sectioned view of the gas turbine engine 24, the exhaust nozzle 44, and the eductor housing 60. Referring to FIGS. 1-3, the eductor housing 60 defines an upstream end portion 70 and a downstream end portion 72. The upstream end portion 70 of the eductor housing 60 connects to the exhaust nozzle 44 and the downstream end portion 72 of the eductor housing 60 connects to the exhaust duct 46 (shown in FIG. 1).

The eductor housing 60 includes a main body 62 defining a longitudinal axis A-A, an inlet opening 84, and an outlet opening 86, where the inlet opening 84 is fluidly connected to the outlet opening 86. Both the inlet opening 84 and the outlet opening 86 of the main body 62 of the eductor housing 60 include an annular profile. The inlet opening 84 and the outlet opening 86 are also aligned with the longitudinal axis A-A of the main body 62. In operation, the exhaust gases E generated by the gas turbine engine 24 enter the eductor housing 60 through the inlet opening 84, mix with the atmospheric air A to form the primary airflow 65, and then exit the eductor housing 60 through the outlet opening 86, wherein the primary airflow 65 then flows through exhaust duct 46. The longitudinal axis A-A of the main body 62 of the eductor housing 60 is aligned with an axis of rotation R-R of the gas turbine engine 24.

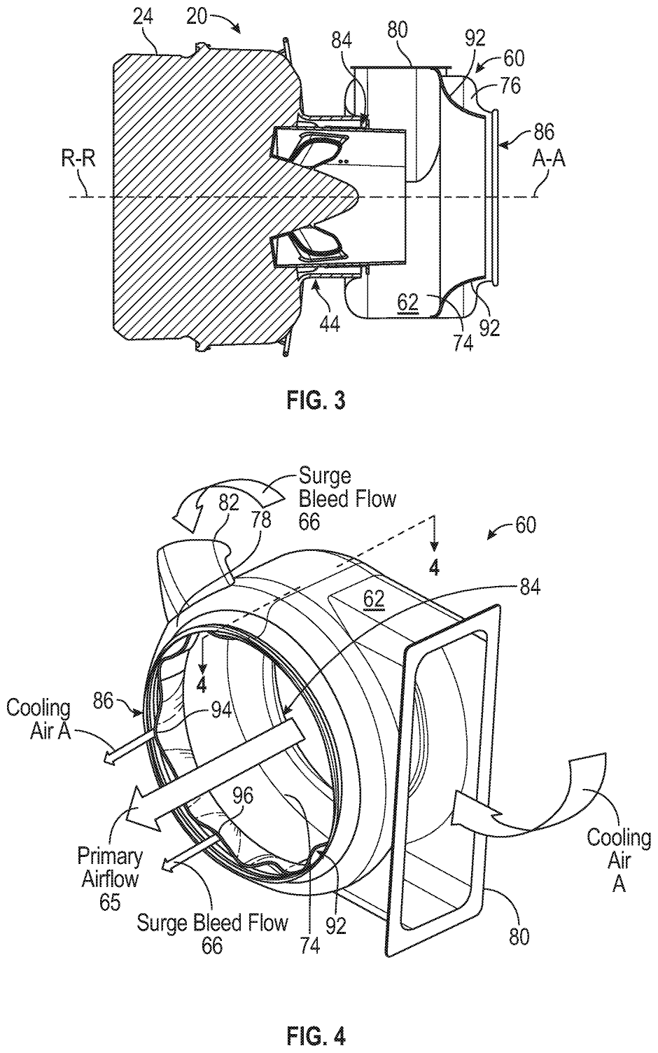

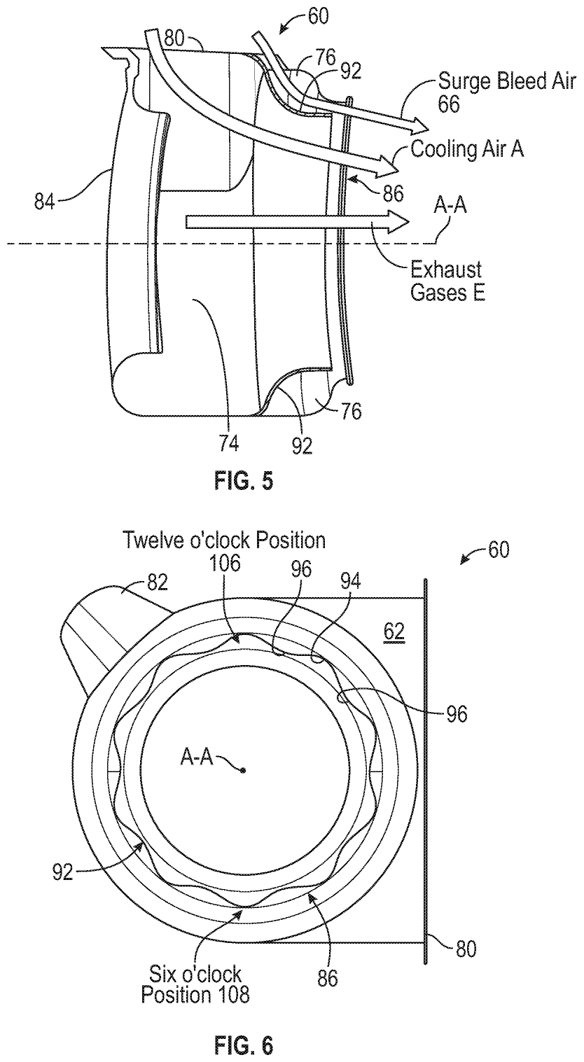

FIG. 4 is a perspective view of the eductor housing 60, and FIG. 5 is a cross-sectioned view of the eductor housing 60 shown in FIG. 4 taken along Section line 4-4. Referring specifically to FIG. 5, the main body 62 of the eductor housing 60 also defines a primary plenum 74 and a secondary plenum 76. The primary plenum 74 includes an annular profile and is circumferentially disposed around and surrounds the exhaust nozzle 44 (FIG. 3). The secondary plenum 76 also includes an annular profile and has a radially outer surface that is defined by a front shroud 78 of the eductor housing 60. Referring to both FIGS. 4 and 5, the primary plenum 74 is separated from the secondary plenum 76 by a plenum divider 92, which is described in more detail below. The primary plenum 74 and the secondary plenum 76 are fluidly connected to the outlet opening 86 of the main body 62 of the eductor housing 60.

The main body 62 of the eductor housing 60 further defines a first opening 80 that is fluidly connected to the primary plenum 74 and a surge bleed duct 82 fluidly connected to the secondary plenum 76. Referring to FIGS. 1, 4, and 5, the first opening 80 of the eductor housing 60 is configured to receive the cooling air A from the compartment 14. It is to be appreciated that the static pressure at the exhaust nozzle 44 is less than the static pressure measured at the first opening 80 of the main body 62 of the eductor housing 60, which is what causes the cooling air A to be drawn into the eductor housing 60. Specifically, as the exhaust gases E generated by the gas turbine engine 24 flow from the exhaust nozzle 44 and through the eductor housing 60, the cooling air A is drawn through the first opening 80 of the eductor housing 60 and into the primary plenum 74. The first opening 80 of the main body 62 of the eductor housing 60 is shaped to receive the oil cooler 26. In the embodiment as shown, the first opening 80 is rectangular in shape to correspond to the oil cooler 26. However, it is to be appreciated that this embodiment is merely exemplary in nature, and the first opening 80 in the eductor housing 60 may include any number of shapes.

Referring to FIGS. 1 and 4, the oil cooler 26 is an oil-to-air heat exchanger that is coupled to the rectangular flange that defines first opening 80 of the main body 62. It is to be appreciated that oil is used as lubrication for the gas turbine engine 24. Thus, as the gas turbine engine 24 is operated, cooling airflow A is drawn through oil cooler 26 and discharged through the first opening 80 of the eductor housing 60. As a result, the cooling air A cools the oil passing through the oil cooler 26. Referring to FIGS. 1, 4, and 5, the cooling air A flows from the first opening 80 and into the primary plenum 74, wherein the spent cooling air A is mixed with and entrained with the exhaust gases from the gas turbine engine 24 to form the primary airflow 65. The primary airflow 65 is then directed out of the eductor housing 60 through the outlet opening 86. In operation, the primary airflow 65 is directed out of the eductor housing 60 through a plurality of lobes 94 (seen in FIG. 4) that are formed in the plenum divider 92. Thus, the cooling air A also facilitates reducing the operational temperature of the engine exhaust gases that exit the eductor housing 60 as well. In the exemplary embodiment the plenum divider 92 is a single unitary component that is shaped to form both the lobes 94 and the chutes 96.

The surge bleed duct 82 of the eductor housing 60 fluidly connects the surge bleed conduit 64 (FIG. 1) with the secondary plenum 76 of the eductor housing 60. The surge bleed duct 82 is configured to receive the surge bleed flow 66 from the surge bleed conduit 64. The secondary plenum 76 directs the surge bleed flow 66 out of the eductor housing 60 through a plurality of chutes 96 that are part of the plenum divider 92. Once, the surge bleed flow 66 exits the secondary plenum 76, the surge bleed flow 66 is mixed with and entrained within the primary airflow 65 that exits the eductor housing 60 through the outlet opening 86. Referring to FIGS. 4 and 5, a first stream of air (i.e., the cooling air A) is directed out of the primary plenum 74 and exits the eductor housing 60 from the plurality of lobes 94 and a secondary stream of air (i.e., the surge bleed flow 66) is directed out of the secondary plenum 76 and exits the eductor housing 60 through the plurality of chutes 96. Thus, it should be appreciated that the plenum divider 92 is disposed around the outlet opening 86 of the eductor housing 60. Moreover, the plenum divider 92 is a single unitary component that is fabricated from a metallic material. Because, the plenum divider 92 is a single component, the both the lobes 94 and the chutes 96 can be formed in the plenum divider 92, using for example a metallic press.

It is to be appreciated that the plenum divider 92 is configured to mix the primary airflow 65 and the surge bleed flow 66. The downstream end of the plenum divider 92 has a sinusoidal profile that defines both the plurality of chutes 96 and the plurality of lobes 94. The plenum divider 92 also separates the primary plenum 74 from the secondary plenum 76.

FIG. 6 is a front view of the eductor housing 60 shown in FIG. 4. The plurality of lobes 94 extend radially outward away from the longitudinal axis A-A of the main body 62 of the eductor housing 60 and the plurality of chutes 96 extend radially inward towards the longitudinal axis A-A of the main body 62 of the eductor housing 60. Referring to FIGS. 4 and 6, the eductor housing 60 includes an annular profile, where both the inlet opening 84 and the outlet opening 86 of the eductor housing 60 are round in shape. In the non-limiting embodiment as shown in FIG. 6, the plurality of lobes 94 are disposed circumferentially around the outlet opening 86 of the eductor housing 60, where the lobes 94 are each spaced equidistant from one another. Similarly, FIG. 6 also illustrates the plurality of chutes 96 disposed circumferentially around the outlet opening 86 of the eductor housing 60, where the chutes 96 are each spaced equidistant from one another.

In one non-limiting embodiment as shown in FIG. 6, the plenum divider 92 includes ten lobes 94 and ten chutes 96. More specifically, the lobes 94 and chutes 96 are configured in an alternating pattern such that each lobe 94 is disposed between a pair of chutes 96 and each chute 96 is disposed between a pair of lobes 94. However, it is to be appreciated that this embodiment is merely exemplary in nature, and the plenum divider 92 may include any number of lobes 94 and chutes 96.

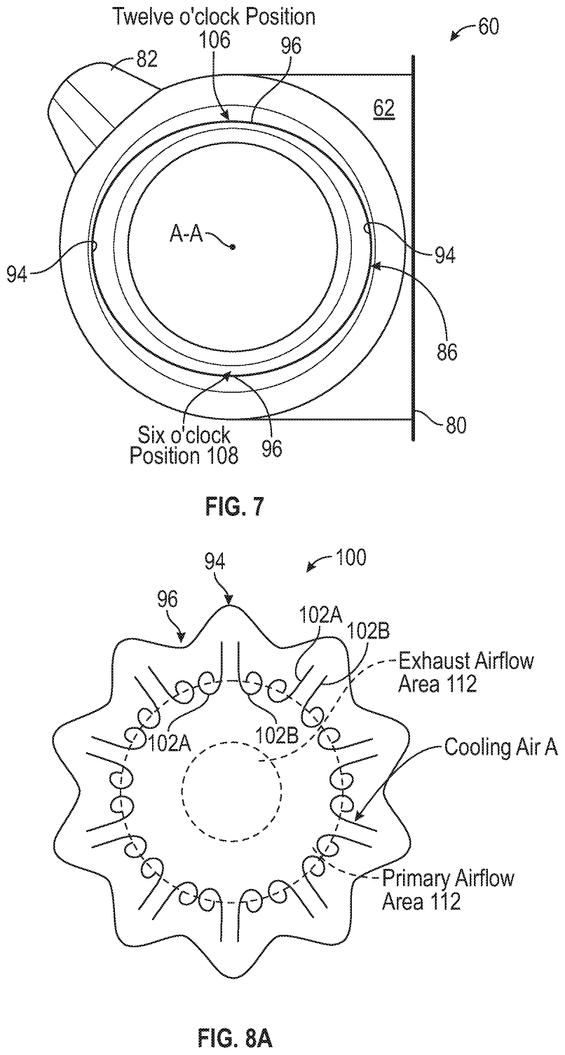

Thus, in another embodiment as shown in FIG. 7, the plenum divider 92 includes only two lobes 94 and two chutes 96. In the embodiment as shown in FIG. 7, the two lobes 94 and the two chutes 96 are spaced equidistant with respect to one another. Specifically, in the exemplary embodiment as shown in FIG. 7, one of the two chutes 96 are positioned at a twelve o'clock position 106, and the remaining chute 96 is disposed at a six o'clock position 108 around the outlet opening 86 of the eductor housing 60. Thus, one of the two lobes 94 is disposed at the three o'clock position and the second of two lobes 94 is disposed at the nine o'clock position.

The number of lobes 94 and chutes 96 are selected based on the specific design and requirements of the eductor assembly 28 (FIG. 1). Some variables that are affected by the number of lobes 94 and chutes 96 include, but are not limited to, airflow noise, an amount of mixing required with the exhaust gases E (FIG. 1), ease of fabrication, cost of manufacturing, and weight. Specifically, in at least some eductor assemblies 28, an increased number of lobes 94 and chutes 96 may lead to an increase in airflow noise. Thus, the embodiment, shown in FIG. 7 may be beneficial to reduce airflow noise and may therefore be installed on aircraft operating in an urban environment. It is also to be appreciated that increasing the number of lobes 94 and chutes 96 also increases the complexity of the eductor housing 60 as well. Accordingly, increasing the number of lobes and chutes 94, 96 decreases the ease of molding the eductor housing 60 as well.

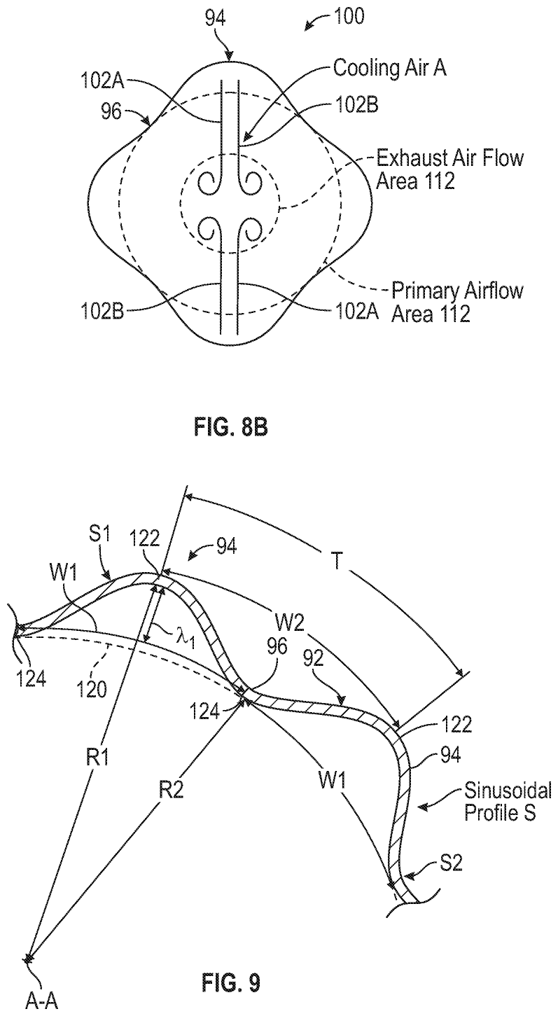

FIGS. 8A and 8B illustrate airflow mixing around a front face 100 of the eductor housing 60, where FIG. 8A illustrates an eductor housing 60 having ten lobes and chutes 94, 96, and FIG. 8B illustrates an eductor housing 60 with two lobes and chutes 94, 96. Referring to both FIG. 8A and 8B, the cooling air A exiting each lobe 94 includes an airflow profile shaped as a pair of opposing vortices 102A, 102B, where the vortex 102A is oriented in a clockwise direction and the vortex 102B is oriented in a counterclockwise direction. Each vortex 102A, 102B is attracted towards to an opposing vortex 102A, 102B disposed in a directly adjacent lobe 94. That is, both FIGS. 8A and 8B illustrate each vortex 102A is attracted towards the vortex 102B in a directly adjacent lobe 94.

In the example as shown in FIG. 8A, each vortex 102A, 102B is relatively close to the opposing vortex 102A, 102B disposed in the directly adjacent lobe 94. Accordingly, each pair of vortices 102A, 102B only extends into an eductor airflow area 110, and not the primary airflow area 112. In contrast, each vortex 102A, 102B shown in FIG. 8B is disposed further apart from an opposing vortex 102A, 12B in the directly adjacent lobe 94. As a result, each pair of vortices 102A, 102B extends radially inward and into the primary airflow area 112. Accordingly, FIGS. 8A and 8B demonstrate that the cooling air A from the compartment 14 (FIG. 1) tends to mix more with the exhaust gases E if the plenum divider 92 (FIG. 4) includes fewer lobes 94.

FIG. 9 is an enlarged view of a portion of the lobes 94 and chutes 96 disposed around the plenum divider 92, where a phantom line 120 is drawn to separate the lobes 94 from the chutes 96. Each lobe 94 includes an overall shape S1, a width W1, and a radial length R1, which may also be referred to herein as the maximum amplitude of the sinusoidal wave that defines the shape of the plenum divider 92. The width W1 of each lobe 94 is measured circumferentially between two trough points 124 that surround a particular lobe 94, and the radial length R1 represents the distance from an apex point 122 of a particular lobe 94 to the longitudinal axis A-A of the eductor housing 60. Similarly, each chute 96 also includes an overall shape S2, a width W2, and a radial length R2. The width W2 of each chute 96 is measured circumferentially between two apex points 122 that surround a particular chute 96, and the radial length R2 represents the distance from the trough point 124 of a particular chute 96 to the longitudinal axis A-A of the eductor housing 60. It is to be appreciated that the plenum divider 92 includes a sinusoidal profile S, where a peak-to-peak amplitude λ₁ of the sinusoidal profile S is measured between a particular apex point 122 and an adjacent trough point 124, and a period T of the sinusoidal profile S is measured from one apex point 122 to an adjacent apex point 122. In the exemplary embodiment shown in FIG. 9, an area defined by each lobe 94 is substantially the same as the area defined by each respective chute 96. More specifically, the cross-sectional area of the chutes 96 is substantially equal to the cross-sectional are of the lobes 94.

In other embodiments, not shown, it is to be appreciated that the lobes 94 may vary in one of more of the overall shape S1, the width W1, and the radial length R1. For example, referring to FIGS. 6 and 9, a portion of the lobes 94 disposed at the twelve o'clock position 106 around the outlet opening 86 of the eductor housing 60 may be greater in width W1 when compared to the lobes 94 disposed at the six o'clock position 108 around the outlet opening 86 of the eductor housing 60. In one embodiment, the widths W1 of the lobes 94 may gradually decrease in size between the twelve o'clock position 106 and the six o'clock position 108 around the outlet opening 86 of the eductor housing 60. Thus, the widths W1 of the lobes 94 vary around the outlet opening 86 of the eductor housing 60. Although the widths W1 are described, in another embodiment the lobes 94 vary by shape S1 or by radial length R1 around the outlet opening 86 of the eductor housing 60. Furthermore, the chutes 96 may also vary in one or more of the overall shape S2, the width W2, and the radial length R1 around the outlet opening 86 of the eductor housing 60.

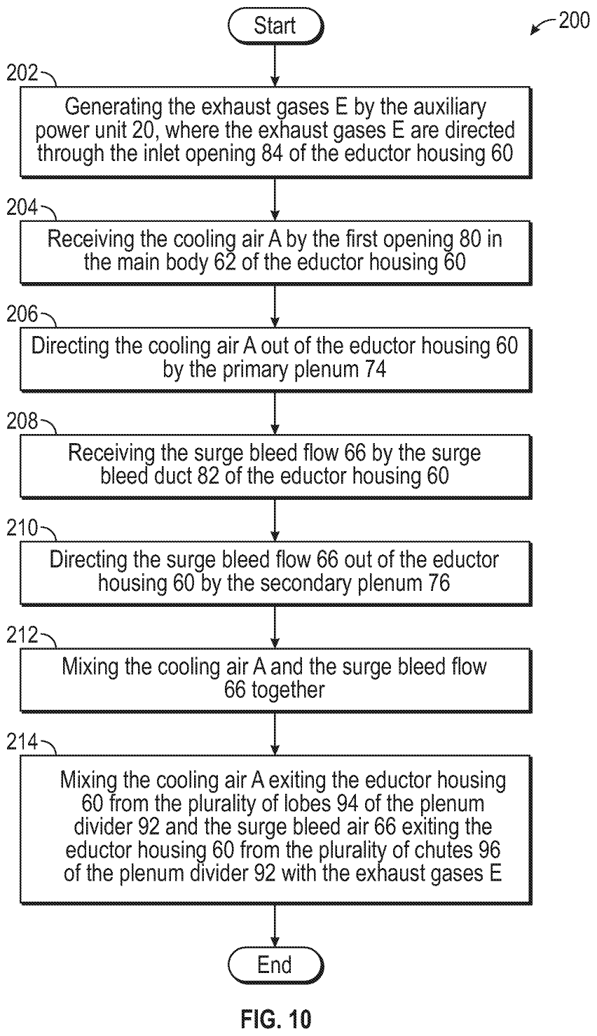

FIG. 10 is an exemplary process flow diagram illustrating a method 200 for mixing the cooling air A with surge bleed flow 66 by the eductor housing 60. Referring generally to FIGS. 1-10, the method 200 begins at block 202. In block 202, the auxiliary power unit 20 (FIG. 1) generates the exhaust gases E, where the exhaust gases E are directed through the inlet opening 84 of the eductor housing 60. As mentioned above, the inlet opening 84 is fluidly connected to the outlet opening 86 of the eductor housing 60. The method 200 may then proceed to block 204.

In block 204, the first opening 80 (FIGS. 2 and 4) in the main body 62 of the eductor housing 60 receives the cooling air A, where the first opening 80 is fluidly connected to the primary plenum 74 of the eductor housing 60. The method 200 may then proceed to block 206.

In block 206, the cooling air A is directed out of the eductor housing 60 by the primary plenum 74, where the cooling air A exits the eductor housing 60 through the plurality of lobes 94 that are part of the plenum divider 92 (FIG. 4). The method 200 may then proceed to block 208.

In block 208, the surge bleed duct 82 in the main body 62 of the eductor housing 60 receives the surge bleed flow 66, where the surge bleed duct 82 is fluidly connected to the secondary plenum 76 of the eductor housing 60. The method 200 may then proceed to block 210.

In block 210, the surge bleed flow 66 is directed out of the eductor housing 60 by the secondary plenum 76. Specifically, the surge bleed flow 66 exits the eductor housing 60 by the plurality of chutes 96 that are part of the plenum divider 92. The method 200 may then proceed to block 212.

In block 212, the cooling air A and the surge bleed flow 66 are mixed together as the cooling air A and the surge bleed flow 66 exit the plenum divider 92 of the eductor housing 60. The method 200 may then proceed to block 214.

In block 214, the cooling air A exiting the eductor housing 60 from the plurality of lobes 94 of the plenum divider 92 and the surge bleed flow 66 exiting the eductor housing 60 from the plurality of chutes 96 of the plenum divider 92 are both mixed with the primary airflow 65, which exits the eductor housing 60 through the outlet opening 86. The method 200 may then terminate.

Referring generally to the figures, the disclosed plenum divider provides various technical effects and benefits. Specifically, the disclosed eductor housing provides an efficient approach to passively cool the exhaust gases generated by the auxiliary power unit before the exhaust gases exit the aircraft. The plurality of lobes and chutes disposed around the outlet opening of the eductor housing promote the mixing of the cooling air and the surge bleed flow together. The cooling air and the surge bleed flow are both entrained within the exhaust gases that exit the eductor housing as well.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An eductor housing for an auxiliary power unit, the eductor housing comprising:
a main body defining a longitudinal axis, a primary plenum, a secondary plenum, an inlet opening, and an outlet opening, the inlet opening fluidly connected to the outlet opening, wherein the primary plenum is separate from the secondary plenum and the primary plenum and the secondary plenum are fluidly connected to the outlet opening of the main body; and
a plenum divider disposed around the outlet opening of the eductor housing and defining a plurality of chutes separated by a plurality of lobes, wherein the plenum divider separates the primary plenum from the secondary plenum and the plurality of lobes extend radially inward towards the longitudinal axis of the main body of the eductor housing.

2. The eductor housing of claim 1, wherein a first stream of air directed out of the primary plenum exits the eductor housing from the plurality of lobes and a second stream of air directed out of the secondary plenum exits the eductor housing from the plurality of chutes.

3. The eductor housing of claim 1, wherein the main body of the eductor housing defines a first opening fluidly connected to the primary plenum.

4. The eductor housing of claim 3, wherein the first opening of the eductor housing is configured to receive cooling air, and wherein the primary plenum directs the cooling air out of the eductor housing through the plurality of lobes.

5. The eductor housing of claim 3, wherein the first opening of the eductor housing is shaped to receive an oil cooler.

6. The eductor housing of claim 1, wherein the main body of the eductor housing defines a surge bleed duct fluidly connected to the secondary plenum.

7. The eductor housing of claim 5, wherein the surge bleed duct is configured to receive surge bleed flow, and wherein the secondary plenum directs the surge bleed flow out of the eductor housing through the plurality of chutes.

8. The eductor housing of claim 1, wherein the plenum divider includes two lobes and two chutes.

9. The eductor housing of claim 8, wherein the two lobes are spaced equidistant with respect to one another.

10. The eductor housing of claim 1, wherein the plurality of lobes vary in one or more of the following: shape, width, and radial length.

11. A method for mixing cooling air with surge bleed flow by an eductor housing, the method comprising:
receiving the cooling air by a first opening in a main body of the eductor housing, wherein the first opening is fluidly connected to a primary plenum of the eductor housing;
directing the cooling air out of the eductor housing by the primary plenum, the cooling air exiting the eductor by a plurality of lobes that are part of a plenum divider;
receiving, by a surge bleed duct in the main body of the eductor housing, the surge bleed flow, wherein the surge bleed duct is fluidly connected to a secondary plenum of the eductor housing;
directing the surge bleed flow out of the eductor housing by the secondary plenum, the surge bleed flow exiting the eductor by a plurality of chutes that are part of the plenum divider; and
mixing the cooling air with the surge bleed flow together as the cooling air and the surge bleed flow exit the eductor housing, wherein the plenum divider is disposed around an outlet opening of the eductor housing.

12. The method of claim 11, further comprising:
generating exhaust gases by an auxiliary power unit; and
directing the exhaust gases through an inlet opening of the eductor housing, wherein the inlet opening is fluidly connected to the outlet opening of the eductor housing.

13. The method of claim 12, further comprising:
mixing the cooling air exiting the eductor housing from the plurality of lobes of the plenum divider and the surge bleed flow exiting the eductor housing from the plurality of chutes of the plenum divider with a primary airflow that exits the eductor housing from the outlet opening.

14. An eductor assembly for an aircraft, comprising:
an auxiliary power unit including a gas turbine engine and a load compressor, wherein the gas turbine engine generates exhaust gases;
an exhaust system including an exhaust nozzle and an exhaust duct, wherein the exhaust gases are expelled from the exhaust nozzle, into the exhaust duct, and exit the aircraft; and
an eductor housing including upstream end portion and a downstream end portion, wherein the upstream end portion of the eductor housing connects to the exhaust nozzle and the downstream end portion of the eductor housing connects to the exhaust duct, and wherein the eductor housing further comprises:
a main body defining a longitudinal axis, a primary plenum, a secondary plenum, an inlet opening, and an outlet opening, the inlet opening fluidly connected to the outlet opening, wherein the primary plenum is separate from the secondary plenum and the primary plenum and the secondary plenum are fluidly connected to the outlet opening of the main body; and
a plenum divider disposed around the outlet opening and defining a plurality of chutes separated by a plurality of lobes, wherein the plenum divider separates the primary plenum from the secondary plenum and the plurality of lobes extend radially inward towards the longitudinal axis of the main body of the eductor housing.

15. The eductor assembly of claim 14, wherein a first stream of air directed out of the primary plenum exits the eductor housing from the plurality of lobes and a second stream of air directed out of the secondary plenum exits the eductor housing from the plurality of chutes.

16. The eductor assembly of claim 14, wherein the main body of the eductor housing defines a first opening fluidly connected to the primary plenum.

17. The eductor assembly of claim 16, wherein the first opening of the eductor housing is configured to receive cooling air, and wherein the primary plenum directs the cooling air out of the eductor housing through the plurality of lobes.

18. The eductor assembly of claim 16, wherein the first opening of the eductor housing is shaped to receive an oil cooler.

19. The eductor assembly of claim 14, wherein the main body of the eductor housing defines a surge bleed duct fluidly connected to the secondary plenum.

20. The eductor assembly of claim 19, wherein the surge bleed duct is configured to receive surge bleed flow, and wherein the secondary plenum directs the surge bleed flow out of the eductor housing through the plurality of chutes.
